(19) United States
(12) Patent Application Publication
(10) Pub. No.: US 2014/0150623 A1
(43) Pub. Date: Jun. 5, 2014

(54) RECORDING AND REPRODUCTION OF WAVEFORM BASED ON SOUND BOARD VIBRATIONS

(71) Applicant: Yamaha Corporation, Hamamatsu-shi (JP)

(72) Inventors: Yuji FUJIWARA, Hamamatsu-shi (JP); Shinya KOSEKI, Fukuroi-shi (JP); Fukutaro OKUYAMA, Hamamatsu-shi (JP)

(73) Assignee: YAMAHA CORPORATION, Hamamatsu-shi (JP)

(21) Appl. No.: 14/095,048

(22) Filed: Dec. 3, 2013

(30) Foreign Application Priority Data
Dec. 3, 2012 (JP) 2012-264190

(51) Int. Cl. G10C 3/06

(52) U.S. Cl. CPC G10C 3/06
USPC 84/192

(57) ABSTRACT

In a musical instrument, such as a piano, having a sound board, the sound board vibrates in response to vibrations of a string responsive to depression of a key. A waveform corresponding to such vibrations of the sound board is detected and recorded. The recorded vibration waveform is usable for reproduction of a sound based on sound board vibrations. In a sound reproduction apparatus, such as a piano, having a sound board, an excitation device physically excitable in response to an input waveform is provided on the sound board. A signal indicative of a vibration waveform of the sound board is received, and the excitation device is driven in accordance with the received waveform signal so that the sound board is vibrated. Thus, a sound based on the sound board vibrations can be replicated or reproduced with a high quality.

### BACKGROUND

The present invention relates generally to a technique which, in a musical instrument provided with a sound board to which physical vibrations of a sounding member like a string are transmitted, permits recording of a vibration waveform related to vibrations of the sound board, and also relates to a sound reproduction apparatus, such as a musical instrument like a piano, capable of generating an audible sound by vibrating a sound board in accordance with a drive signal indicative of a vibration waveform of the sound board.

There have heretofore been known pianos constructed to record data of a keyboard performance and execute an automatic performance by driving keys on the basis of the recorded keyboard performance data. In such auto-playing pianos, strings are actually struck through automatic driving of the keys, and sounds very similar to sounds generated during the recording of the keyboard performance can be reproduced. If behavior of a pedal too is recorded and reproduced, it is possible to even more faithfully reproduce sounds generated during the recording. However, basically, sound volumes cannot be adjusted because the strings are actually struck.

Also known, for example, from Japanese Patent Application Laid-open Publication No. HEI-5-73039 and Published Japanese Translation of International Patent Application No. 2006-524350 are pianos which can compulsorily vibrate a sound board by an actuator in accordance with a drive signal in addition to vibrations caused by the string striking.

In the piano disclosed in Japanese Patent Application Laid-open Publication No. HEI-5-73039, vibrations of any one of the strings and the sound board during a performance are detected via vibration sensors and a microphone, DSP processing is performed on the detected vibrations to generate a sound board drive signal so that the actuator is driven to vibrate the sound board within five msec from sound generation by striking of the string. Thus, a sound generated by vibrations of the sound board via the actuator is added to a sound of an acoustic piano, so that it is possible to set as desired a type and variation amount of an audio effect to be imparted in a performance.

However, with the piano disclosed in Japanese Patent Application Laid-open Publication No. HEI-5-73039, where the sound board and the stings are in such a relationship that vibrations are transmitted mutually between them, a resonant sound resulting from compulsory vibrations of the sound board etc. are generated in addition to a sound generated by striking of any one of the strings. Thus, the sound generated by the string striking and the sound by the compulsory vibrations of the sound board mix together to cause a resonant-sound overlapping state, so that an unintended acoustic effect may be undesirably produced.

Because sounds of different quality from original sounds of the acoustic piano are generated for the foregoing reason, the technique disclosed in the No. HEI-5-73039 publication differs from a technique intended to faithfully replicate or reproduce original acoustic characteristics of an acoustic piano in a performance. In addition, the technique disclosed in the No. HEI-5-73039 publication is not a technique designed to execute automatic reproduction using data obtained by recording a performance. Further, because the technique disclosed in the No. HEI-5-73039 publication is constructed to merely generate sounds by compulsory vibrations of the sound board in addition to sounds generated by string striking, it can hardly adjust sound volumes during a performance. Further, Published Japanese Translation of International Patent Application No. 2006-524350 does not disclose recording and reproducing vibrations of the sound board.

### SUMMARY OF THE INVENTION

In view of the foregoing prior art problems, it is an object of the present invention to provide an improved musical instrument which can record a vibration waveform pertaining to vibrations of a sound board rather than vibrations of a sounding member, such as a string, that is a primary vibration sound source of the musical instrument. It is another object of the present invention to provide an improved sound reproduction apparatus which can generate a sound by driving the sound board on the basis of such vibrations of the sound board. It is still another object of the present invention to provide a piano which can faithfully reproduce, in reproduction of music piece data obtained by recording a performance of a music piece, the same acoustic characteristics as an acoustic piano as presented in the performance recording.

In order to accomplish the above-mentioned objects, the present invention provides an improved musical instrument, which comprises: at least one performance operation key; at least one sounding member each provided in association with one of said at least one performance operation key; a sound board; at least one striking member each configured to physically vibrate one of said at least one sounding member in response to an operation of said at least one performance operation key; a transmission joint disposed in such a manner as to physically transmit vibrations of said at least one sounding member to said sound board; a vibration waveform detector configured to detect a vibration waveform corresponding to vibrations of at least one of said sound board and said transmission joint; and a controller configured to perform control for storing, into a memory, a time series of the vibration waveforms detected by said vibration waveform detector in correspondence with a music piece or phrase performed using said at least one performance operation key.

With such a musical instrument of the present invention, control can be performed to record a vibration waveform pertaining to vibrations of the sound board rather than vibrations of the sounding member (e.g., string) that is a primary vibration sound source of the musical instrument. Thus, the recorded vibration waveform can be advantageously used for sound reproduction. For example, sounds of the music piece or phrase based on vibrations of the sound board can be reproduced by the sound board being automatically vibrated on the basis of the recorded time series of the vibration waveforms.

According to another aspect of the present invention, there is provided an improved sound reproduction apparatus, which comprises: a sound board; an excitation device physically excitable in accordance with an input waveform signal and disposed in such a manner that physical vibrations generated by the excitation device are transmitted at least to the sound board; and a controller configured to receive a signal indicative of a vibration waveform of the sound board and input the received signal indicative of the vibration waveform to the excitation device, so that physical vibrations according to the input signal indicative of the vibration waveform are generated by the excitation device and a sound is generated by at least the sound board physically vibrating in response to the physical vibrations generated by the excitation device. With such a sound reproduction apparatus of the present invention, a sound based on vibrations of the sound board faithfully reproducing a given vibration waveform can be generated by the sound board, provided in the sound reproduction apparatus itself, being driven on the basis of the received signal indicative of the vibration waveform.

Preferably, in the sound reproduction apparatus of the present invention, said signal indicative of the vibration waveform received by the controller comprises a time series of vibration waveforms corresponding to a music piece or phrase so that sounds of the music piece or phrase are generated by the physical vibrations of the sound board.

Preferably, in the sound reproduction apparatus of the present invention, the vibration waveform is a vibration waveform detected by a vibration waveform detector of a musical instrument, and the musical instrument comprises: at least one performance operation key; at least one sounding member configured to physically vibrate in response to an operation of the at least one performance operation key; a sound board; a transmission joint disposed in such a manner as to physically transmit vibrations of the at least one sounding member to the sound board; and the vibration waveform detector configured to detect a vibration waveform corresponding to vibrations of at least one of the sound board and the transmission joint. Thus, a sound is reproduced on the basis of the vibration waveform recorded based on an actual performance on the music instrument (e.g., acoustic piano) (e.g., data of a continuous vibration waveform obtained on the basis of a performance of a music piece), so that the same acoustic characteristics of the music instrument (e.g., acoustic piano) as presented in the recording of data of the performance can be faithfully reproduced and sound volume adjustment etc. can be made.

Preferably, the sound reproduction apparatus of the present invention is mounted on the musical instrument, and the excitation device is a device comprising the same hardware as the vibration waveform detector. Thus, the same acoustic characteristics as presented in the data recording can be even more faithfully, but also the construction of the sound reproduction apparatus can be simplified.

Preferably, the sound reproduction apparatus of the present invention further comprises a drive unit configured to automatically drive the at least one performance operation key, and the controller receives, in association with the received signal indicative of the vibration waveform, information identifying the at least one performance operation key and automatically drives the at least one performance operation key via the drive unit on the basis of the received information identifying the at least one performance operation key. Thus, sound control (e.g., damper control and velocity control) responsive to an operation of the performance operation key can be performed additionally; so that controllability and quality of the sound based on vibrations of the sound board can be enhanced.

Preferably, the sound reproduction apparatus further comprises a prevention device configured to prevent the at least one sounding member from physically vibrating in response to an operation of the at least one performance operation key, and, when the controller automatically drives the at least one performance operation key via the drive unit on the basis of the received information identifying the at least one performance operation key, the controller actuates the prevention device to prevent the at least one sounding member from physically vibrating. With such arrangements, the sound reproduction apparatus can present the sounding member from generating a sound and thereby generate a sound based purely on vibrations of the sound board.

Preferably, the sound reproduction apparatus further comprises a damper device operable to damp vibrations of the at least one sounding member; and a damper drive unit configured to automatically drive the damper device. The controller receives, in association with the received signal indicative of the vibration waveform, information indicative of behavior of the damper device and automatically drives the damper device via the damper drive unit on the basis of the information indicative of the behavior of the damper device. Thus, sound control responsive to behavior of the damper device can be performed additionally, so that controllability and quality of the sound based on vibrations of the sound board can be enhanced.

The present invention may be constructed and implemented not only as the apparatus invention discussed above but also as a method invention. Also, the present invention may be arranged and implemented as a software program for execution by a processor, such as a computer or DSP, as well as a non-transitory computer-readable storage medium storing such a software program. In this case, the program may be provided to a user in the storage medium and then installed into a computer of the user, or delivered from a server apparatus to a computer of a client via a communication network and then installed into the client's computer. Further, the processor used in the present invention may comprise a dedicated processor with dedicated logic built in hardware, not to mention a computer or other general-purpose processor capable of running a desired software program.

The following will describe embodiments of the present invention, but it should be appreciated that the present invention is not limited to the described embodiments and various modifications of the invention are possible without departing from the basic principles. The scope of the present invention is therefore to be determined solely by the appended claims.

### BRIEF DESCRIPTION OF THE DRAWINGS

Certain preferred embodiments of the present invention will hereinafter be described in detail, by way of example only with reference to the accompanying drawings, in which:

FIG. 1 is a perspective view showing an outer appearance of a first embodiment of a grand piano of the present invention;

FIG. 2 is a sectional view showing an internal construction of the first embodiment of the grand piano;

FIG. 3 is a bottom plan view of a sound board explanatory of mounted positions of vibration sensor/actuator units in the embodiment;

FIG. 4 is a block diagram showing a construction of a sound generator device of the embodiment of the grand piano;

FIG. 5A is a diagram showing propagation paths of vibrations during recording processing where music piece reproducing data are recorded in a string striking mode;

FIG. 5B is a diagram showing propagation paths of vibrations during music piece reproduction processing where sounds are audibly generated via the sound board on the basis of the music piece reproducing data in a string-striking preventing mode;

FIG. 6 is a flow chart of the recording processing performed in the embodiment of the grand piano;

FIG. 7 is a flow chart of the music piece reproduction processing performed in the embodiment of the grand piano;

FIG. 8A is a diagram showing propagation paths of vibrations during the recording processing where music piece reproducing data are recorded in the string striking mode in a second embodiment of the piano; and

FIG. 8B is a diagram showing propagation paths of vibrations during the music piece reproduction processing where sounds are audibly generated via the sound board on the basis of the music piece reproducing data in the string-striking preventing mode in the second embodiment.

### DETAILED DESCRIPTION OF THE INVENTION

### First Embodiment

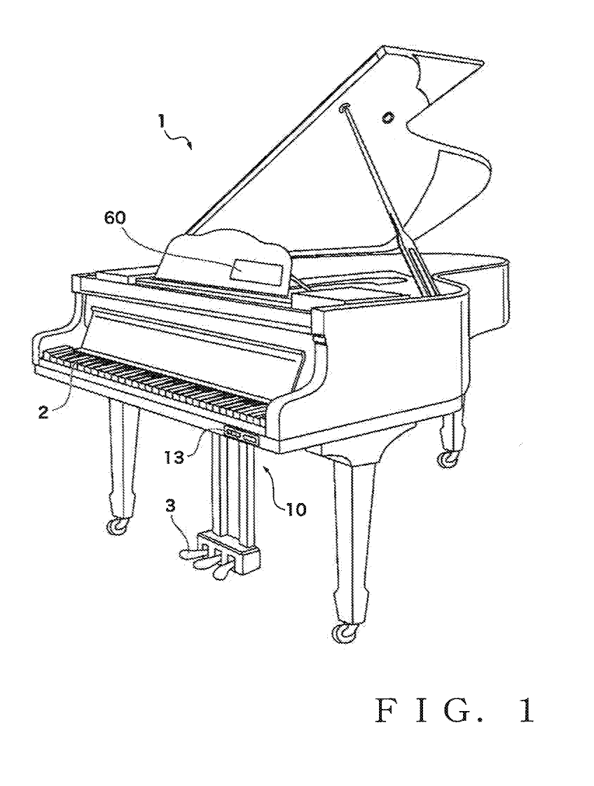

FIG. 1 is a perspective view showing an overall outer appearance of a first embodiment of a piano of the present invention. This piano is constructed as a grand piano 1, which includes a keyboard having a plurality of keys 2 arranged on a front side thereof and operable by a human player for a performance and sound controlling pedals 3. The grand piano 1 further includes a sound generator device 10 having an operation panel 13 on a front surface portion thereof and a touch panel 60 provided on a music stand portion of the piano. A user can input instructions to the sound generator device 10 by operating the operation panel 13 and the touch panel 60. The piano 1 has functions as a musical instrument equipped with a recording function according to the present invention and as a sound reproduction apparatus according to the present invention.

The grand piano 1 can be set in a plurality of sound generation modes in accordance with user's instructions. The plurality of sound generation modes include a string striking mode in which a sound is generated only by a hammer striking a corresponding string (more specifically, a set of one or more strings, but such a set of strings will hereinafter be referred to merely as a string) of the piano, and a string-striking preventing mode in which striking of a string by a hammer is prevented even when a corresponding key has been depressed. The string striking mode includes not only a normal performance mode similar to that of an ordinary grand piano, but also an automatic performance mode. Although the string-striking preventing mode may be set also as a so-called silencing mode in which only electronic sound generation is executed in place of sound generation by string striking, the string-striking preventing mode in the instant embodiment is capable of executing sound generation by a sound board in place of sound generation by string striking and without executing electronic sound generation. In the instant embodiment, the above-mentioned functions as the musical instrument equipped with the recording function according to the present invention can be performed in the string striking mode. Further, the functions as the sound reproduction apparatus according to the present invention can be performed in the string-striking preventing mode.

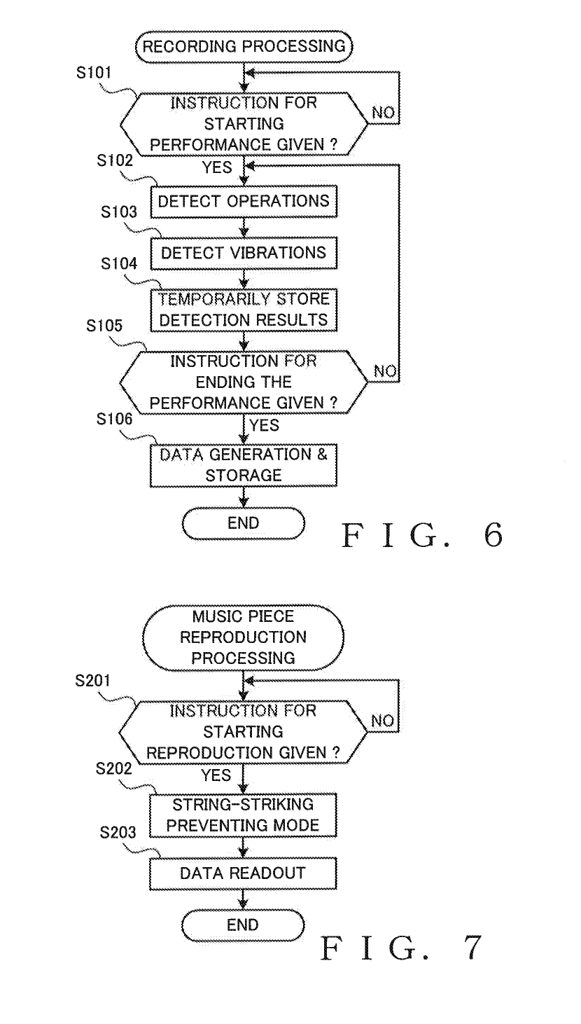

The above-mentioned automatic performance mode includes a mode in which electronic sound generation is executed, ad a mode in which sound generation by the sound board is executed. Music piece reproduction processing for reproducing music piece reproducing data (see FIG. 7) corresponds to the mode in which sound generation by the sound board is executed.

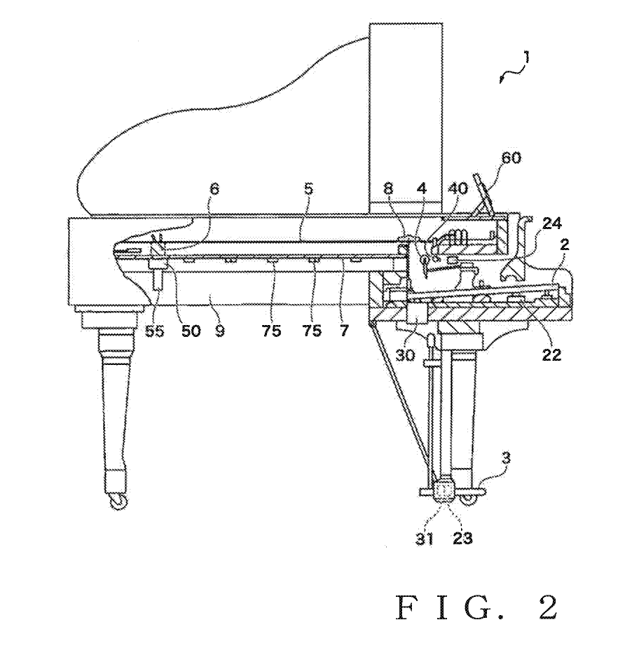

FIG. 2 is a sectional view showing an internal construction of the grand piano 1. In FIG. 2, only a construction of one of the keys 2 and various sections corresponding to the one key 2 is shown for simplicity of illustration. Below a rear end portion (i.e., an end portion farther from a user or human player of the grand piano 1) of each of the keys 2 are provided a key drive unit 30 that drives the key 2 via a solenoid when the performance mode (sound generation mode) is the automatic performance mode or the like. Below the rear end portions of the keys 2 are also provided pedal drive units 31 that drive the pedals 3 via solenoids in the automatic performance mode or the like. In the instant embodiment, the keys 2 of the piano 1 are performance operation keys in the musical instrument equipped with the recording function according to the present invention.

The key drive unit 30 and the pedal drive unit 31 drive the solenoids in accordance with respective control signals (or drive signals) given from the sound generator device 10. The key drive unit 30 reproduces a state similar to that when the user has depressed any one of the keys, by driving the corresponding solenoid to move upward the solenoid plunger. Also, the key drive unit 30 reproduces a state similar to that when the user has released any one of the keys, by moving downward the corresponding solenoid plunger. The pedal drive unit 31 reproduces a state similar to that when the user has depressed any one of the pedals 3, by driving the corresponding solenoid to move upward the solenoid plunger. Also, the pedal drive unit 31 reproduces a state similar to that when the user has released the pedal, by moving downward the corresponding solenoid plunger. The key drive unit 30 functions as a drive unit that automatically drives the performance operation key (key 2).

A plurality of strings 5 and hammers 4 are provided in corresponding relation to the keys 2. As any one of the keys 2 is depressed, the corresponding hammer 4 pivots via an action mechanism (not shown) to strike the corresponding string 5. A damper 8 is displaced in accordance with a depressed amount of the key 2 and a depressed amount of a damper pedal (hereinafter, the pedal 3 refers to the damper pedal unless stated otherwise) so that the damper 8 is placed out of contact with the string or in contact with the string 5. When the damper 8 is in contact with the string 5, it suppresses vibrations of the string 5. When any one of the keys 2 has been depressed, only the damper 8 corresponding to the depressed key 2 is displaced. In the instant embodiment, the string 5 is a sounding member of the musical instrument equipped with the recording function according to the present invention, and the hammer 4 is a striking member of that musical instrument. Further, the damper pedal and the dampers 8 will hereinafter be referred to collectively as a damper device, The pedal drive unit 31 functions as a damper drive unit that automatically drives the damper device.

A stopper 40 is a string-striking preventing member or means which, While the grand piano 1 is in the string-striking preventing mode, operates to stop the hammers 4 and thereby prevent the hammers 4 from striking the strings 5. With the stopper 40 displaced to a position corresponding to the string-striking preventing mode, hammer shanks abut against the stopper 40 and thus are prevented from pivoting, so that the hammers 4 do not abut against the strings 5. In the string striking mode, however, the stopper 40 is kept evacuated to such a position as to not interfere with the hammer shanks.

A plurality of key sensors 22 are provided in corresponding relation to and beneath the individual keys 2 and output to the sound generator device 10 detection signals corresponding to behavior of the corresponding keys 2. For example, each of the key sensors 22 detects a depressed amount of the corresponding key 2 and outputs a detection signal indicative of the detection result to the sound generator device 10. Note that each of the key sensors 22 may be constructed to output a detection signal indicating that the corresponding key 2 has passed one or more particular depressed positions. The key sensor 22 functions as an operation detector that detects an operation of the performance operation key.

A plurality of hammer sensors 24 are provided in corresponding relation to the hammers 4 and output to the sound generator device 10 detection signals corresponding to behavior of the corresponding hammers 4. For example, each of the hammer sensors 24 detects a moving velocity of the corresponding hammer 4 immediately before striking the corresponding string 5 and outputs to the sound generator device 10 a detection signal indicative of the detection result. Note that each of the hammer sensors 24 may be constructed to output a detection signal indicating that the corresponding hammer 2 has passed one or more particular pivoted positions.

A plurality of pedal sensors 23 are provided in corresponding relation to the sound controlling pedals 3 and output to the sound generator 10 detection signals corresponding to behavior of the corresponding pedals 3. In the illustrated example, one of the pedal sensors 23 detects a depressed amount of the damper pedal 3 and outputs to the sound generator device 10 a detection signal indicative of the detection result. Note that the pedal sensor 23 may be constructed to output a detection signal indicating that the pedal 3 has passed a particular depressed position. The pedal sensor 23 for the damper pedal functions as a damper behavior detector that detects behavior of the damper device.

Here, the “particular depressed position” is preferably a depressed position by which it can be identified whether the string 5 and the damper 8 are in contact with each other or out of contact with each other. It is further preferable that a plurality of such particular depressed positions be provided to permit detection of a half-pedal state as well. Note that the detection signal output from the pedal sensor 23 may be any type of signal as long as it allows the sound generator device 10 to identify behavior of the pedal 3.

In order to execute a performance in the silencing mode, it is only necessary that, for each of the keys 2 (key numbers), the sound generator device 10 be capable of identifying a time of striking, by the hammer 4, of the string 5 (i.e., key-on time), striking velocity and a time of vibration suppression, by the damper 8, of the string 5 (key-off time) in accordance with detection signals output from the key sensor 22, pedal sensor 23 and hammer sensor 24. Thus, the key sensor 22, pedal sensor 23 and hammer sensor 24 may be constructed to output detected behavior of the key 2, pedal 3 and hammer 4 as any other desired forms of detection signals.

Ribs (braces or belly bars) 75 and a bridge 6 are provided on the sound board 7, and the bridge 6 engages a portion of each of the strings 5 to support the string 5 in a stretched-taut state. Thus, vibrations of the sound board 7 are transmitted to the individual strings 5 via the bridge 6, and vibrations of the individual strings 5 are transmitted to the sound board 7 via the bridge 6. The bridge 6 is a transmission joint disposed in such a manner as to physically transmit vibrations of the string 5 (sounding members) to the sound board 6.

Further, one or more vibration sensor/actuator units 50 is provided on the sound board 7. The vibration sensor/actuator units 50 each include an actuator having an excitation function for transmitting vibrations to the sound board 7, and a drive circuit for driving the actuator. The drive circuit amplifies a sound board drive signal (drive waveform signal) output from the sound generator 10 and supplies the amplified drive signal to the actuator so that the actuator is vibrated in accordance with a waveform indicated by the drive signal. Further, the vibration sensor/actuator unit 50 functions also as a vibration waveform detecting sensor that continuously detects (picks up) a vibration waveform of the sound board 7.

The vibration sensor/actuator units 50 are each supported by a support section 55 connected to a straight strut 9 and are each connected to the sound board 7. Alternatively, the vibration sensor/actuator units 50 may each be supported by the sound board 7 without the support section 55 being used. In this case, the vibration sensor/actuator units 50 each transmit to the sound board 7 vibrations responsive to the drive signal by inertial force.

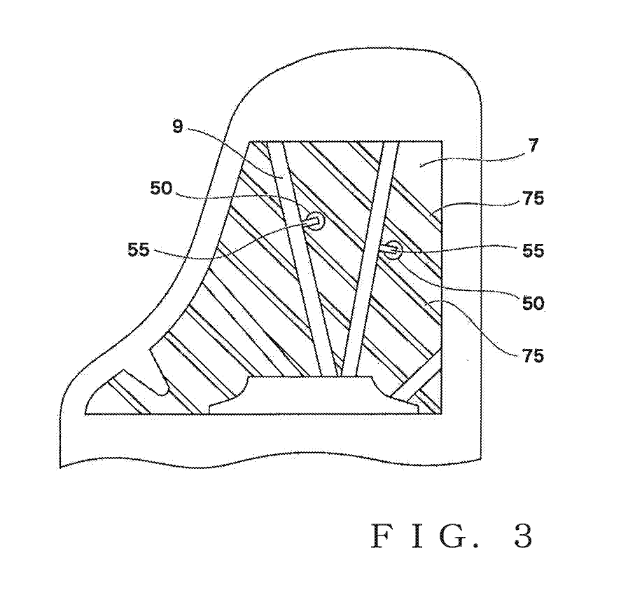

FIG. 3 is a bottom plan view of the sound board 7 explanatory of mounted positions of the vibration sensor/actuator units 50. The vibration sensor/actuator units 50 are each disposed on the sound board 7 between adjoining ones of the ribs (braces) 75 and connected to the sound board 7 in such a manner as to be capable of physically transmitting vibrations to the sound board 7. Although a plurality of the vibration sensor/actuator units 50 of a same construction are provided in the illustrated example, only one vibration sensor/actuator units 50 may be provided. For convenience, the following description will be given on the assumption that only one vibration sensor/actuator unit 50 is provided.

As shown in FIG. 2, the vibration sensor/actuator unit 50 is disposed as close to the bridge 6 as possible. In the instant embodiment, the vibration sensor/actuator unit 50 is disposed on a side of the sound board 7 opposite from the bridge 6; in the illustrated example, each of the vibration sensor/actuators units 50 is disposed on a lower side of the sound board 7, while the bridge 6 is disposed on an upper side of the sound board 7. With the vibration sensor/actuator unit 50 disposed close to the bridge 6, there can be provided conditions similar to those where the bridge 6 itself is excited and vibration waveforms of the bridge 6 themselves are detected. Namely, the vibration sensor/actuator unit 50 is a vibration waveform detector that detects a vibration waveform corresponding to vibrations of at least one of the sound board 7 and bridge 6 (transmission joint), but also constitutes an excitation device that is physically excited in accordance with an input waveform signal.

A device comprising a combination of a voice coil and a permanent magnet may be employed as a specific example of the vibration sensor/actuator unit 50, in which case the voice coil is connected to the sound board 7 while the permanent magnet is fixed to a piano frame or a suitable base. When the vibration sensor/actuator unit 50 should be caused to function as the vibration sensor, an AC signal induced from the voice coil in response to physical vibrations of the voice coil is output as a vibration waveform detection signal. When the vibration sensor/actuator unit 50 should be caused to function as the actuator (excitation device), a waveform signal is input to the voice coil so that the voice coil is physically vibrated in accordance with the input waveform signal.

Alternatively, the vibration sensor and the actuator may be constructed as separate devices. In such a case, the vibration sensor may comprise other than a combination of the voice coil and the permanent magnet; for example, the vibration sensor may comprise a strain detector, such as a piezoelectric device, another fine displacement detector or the like. Further, a suitable vibrator may be employed as the actuator (excitation device).

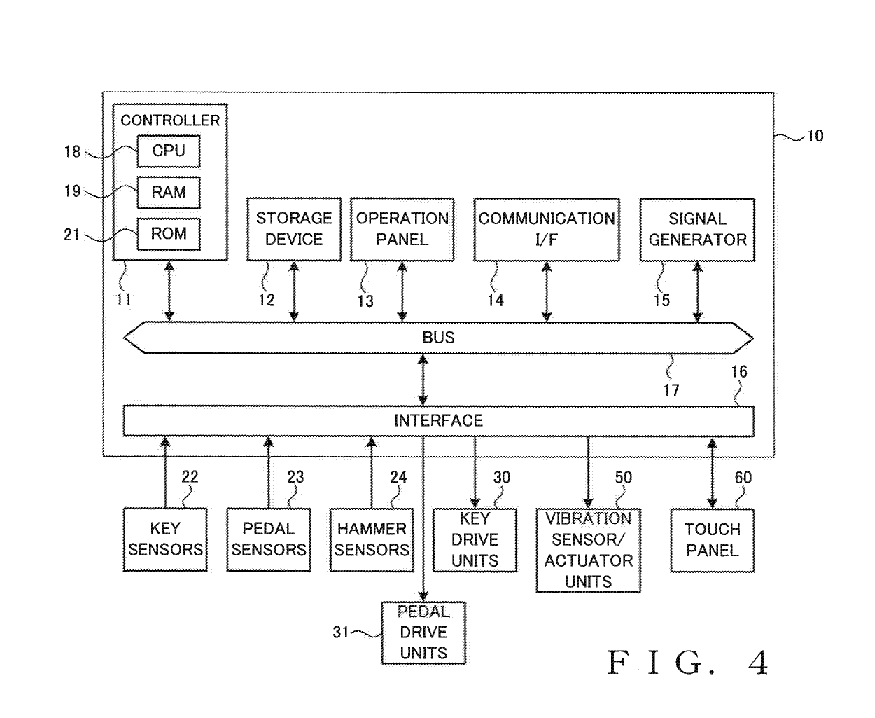

FIG. 4 is a block diagram showing an overall construction of the sound generator device 10 of the grand piano 1 and other components related to the sound generator device 10. The sound generator device 10 includes a controller 11, a storage device 12, the operation panel 13, a communication I/F 14, a signal generation section 15 and an interface 16, and these components are interconnected via a bus 17.

The controller 11 includes a CPU 18 and storage devices such as a RAM 19, a ROM 21, etc. On the basis of control programs stored in the ROM 21, the controller 11 controls various sections of the sound generator device 10 and various components connected to the interface 16.

The storage device 12 stores therein setting information indicative of various setting content to be used while the control programs are being executed. The setting information is information that, on the basis of detection signals output from the key sensor 22, pedal sensor 23 and hammer sensor 24, determines content of drive signals to be generated in the signal generation section 15. The setting information includes, for example, a table defining relationship between depressed keys 2 and drive signals. The storage device 12 also stores “pedal drive data”, “key drive data” and “music piece reproducing data” recorded in recording processing of FIG. 6.

The pedal drive data is data for generating a pedal drive signal to drive the pedal drive unit 31. The key pedal data is data for generating a key drive signal that drives a key drive unit 30. These drive data are, for example, MIDI data. Further, the music piece reproducing data includes vibration waveform data on the basis of which to generate a sound board drive signal (waveform signal) that drives the vibration sensor/actuator unit 50.

The operation panel 13 includes operation buttons etc. operable by the user or capable of receiving user's operations. Once a user's operation is received via any one of the operation buttons, an operation signal corresponding to the operation is output to the controller 11. The touch panel 60 connected to the interface 16 has a display screen that displays thereon a setting screen for making settings for various modes and displays various information, such as a musical score. User's instructions to the sound generator device 10 can be input via any one of the operation panel 13 and the touch panel 60.

The communication I/1F 14 is an interface for executing communication between the piano 1 and an external device in a wireless or wired manner. A disk drive for reading out various data stored in a recording medium may be connected to the communication I/F 14. Among data input to the sound generator device 10 via the communication I/F 14 are, for example, music piece data for use in an automatic performance.

On the basis of the “pedal drive data”, “key drive data” and “music piece reproducing data”, the signal generation section 15 outputs drive signals with reference to a not-shown fundamental-characteristic-key table, a fundamental-note-AEG (Amplitude Envelope Generator) key table, etc.

The interface 16 interconnects the sound generator device 10 and various external components. The interface 16 outputs to the controller 11 detection signals received from the key sensors 22, pedal sensor 23 and hammer sensors 24 and operation signals received from the touch panel 60. Further, the interface 16 outputs control signals from the controller 11 to the key drive unit 30 and pedal drive unit 31, but also outputs drive signals from the signal generation section 15 to the vibration sensor/actuator unit 50.

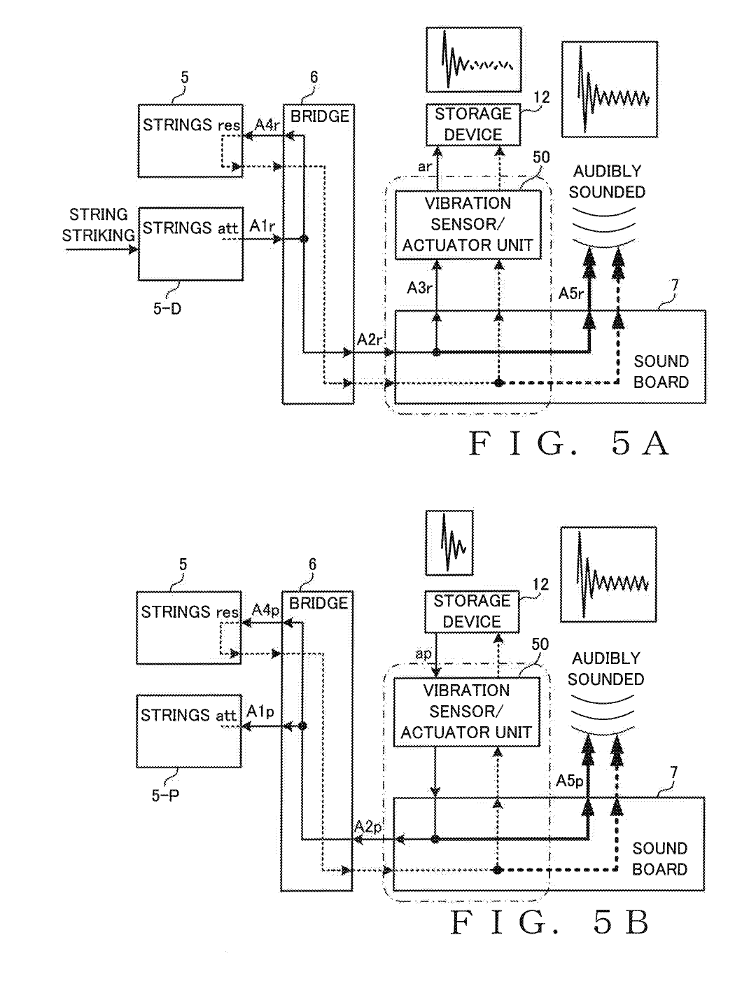

FIG. 5A is a diagram showing vibration propagation paths in the string striking mode, i.e. during the recording processing in which music piece reproducing data or sound-reproducing vibration waveform data are recorded. FIG. 5B is a diagram showing vibration propagation paths in the string-striking preventing mode, i.e. during the music piece reproduction processing (or sound reproduction processing) in which sound board sound generation by the sound board is performed on the basis of music piece reproducing data or vibration waveform data.

First, in the recording processing, as shown in FIG. 5A, the user performs performance operations for a desired music piece or desired sound generation using the keys 2 and pedals 3.

in the recording processing, when the string 5-D corresponding to a depressed key 2 in accordance with a recording start instruction has been struck by the corresponding hammer 4, the corresponding damper 8 is not in contact with the string 5-D because the damper 8 has been moved upward out of contact with the string 5-D due to the key depression. As shown in FIG. 5A, first, vibrations of the struck string 5-D are transmitted to the bridge 6 (see arrow A1r), via which the vibrations are transmitted to the sound board 7 (arrow A2r). Meanwhile, the vibrations of the struck string transmit via the bridge 6 to the sound board 7 (arrow A4r). The vibrations of the sound board 7 are audibly sounded in the air (arrow A5r), but also detected by the vibration sensor/actuator unit 50 (arrow A3r) and converted into a waveform signal (arrow ar). Such operations are sequentially performed per key depression and temporarily stored in the RAM 19 of the controller 1, and then, resultant vibration waveform data of the performed keys, sequentially stored in the RAM 19, are stored into the storage device 12 as a set of music reproducing data.

Further, in the recording processing, as will be detailed later in relation to FIG. 6, respective behavior of the keys 2 and pedals 3 is detected in parallel with detection of the vibration waveform of the sound board 7, from the results of which key drive data and pedal drive data are stored into the storage device 12 in association with the music piece reproducing data. The key drive data include at least information identifying each key depressed, and the pedal drive data include at least information indicative of behavior of the damper device.

In the music piece reproduction processing, the piano 1 is set in the string-striking preventing mode so that striking of any strings 5 is prevented, but the sound board 7 is excited on the basis of the music piece reproducing data so that sound generation is executed on the basis of vibrations of the sound board 7. Further, as will be detailed later in relation to FIG. 7, the key 2 and pedal 3 are automatically driven on the basis of the key drive data and pedal drive data, so that the damper 8 moves in response to the behavior of the key 2 and pedal 3.

The controller 11 sequentially read out the music piece reproducing data, which are vibration waveform data stored in the storage device 12, into the RAM 19. Then, as shown in FIG. 5B, the controller 11 sends a drive signal (arrow ap), generated by the signal generation section 15 on the basis of the sequentially read-out waveform data, to the vibration sensor/actuator unit 50. Thus, the vibration sensor/actuator unit 50 can excite the sound board 7 with the same vibration waveform with which the sound board 7 was vibrated during the recording processing (i.e., with the same vibration waveform as in the recording processing).

Vibrations of the thus-excited sound board 7 are audibly sounded in the air (arrow A5p) but also transmits to the bridge 6 (arrow A2p). The vibrations of the sound board 7 then transmits from the bridge 6 to the string 5-P and other strings 5 released from the dampers 8 due to the automatic driving of the key 2 and pedal 3 (arrow Alp and arrow A4p). Thus, the string 5-P and the other strings 5 resonate, and such resonant vibrations transmit to the bridge 6, from which the resonant vibrations transmit to the sound board 7 to be audibly sounded in the air but also transmit to the vibration sensor/actuator unit 50.

Thus, the instant embodiment can audibly generate a same sound via the sound board 7 as when any one of the strings has been struck, without actually striking the string in response to depression of a key.

Next, with reference to FIGS. 6 and 7, a description will be given about example operational sequences of the recording processing and the music piece reproduction processing performed in the instant embodiment.

FIG. 6 is a flow chart of the recording processing, which is performed by the CPU 18 of the controller 11. First, the CPU 18 makes a determination, at step S101, as to whether the user has given an instruction for starting a performance of a music piece. If the instruction for starting a performance has been given by the user as determined at step S101, the CPU 18 goes to step S102, where it sets the sound generation mode in the string striking mode as in a normal performance and causes the key sensors 22, pedal sensor 23 and hammer sensors 24 to detect operations of the keys 2, pedal 3 and hammers 4, respectively. At this time, using the keys 2, the user act to perform a desired music piece, phrase or the like. Then, the CPU 18 controls the air vibration sensor/actuator unit 50 to detect vibrations of the sound board 7, at step S103.

Then, at step S104, the CPU 18 temporarily stores into the RAM 19 detection results of the key sensors 22, pedal sensor 23 and hammer sensors 24 and vibration waveform data obtained from detection results of the air vibration sensor/actuator unit 50.

Then, at step S105, the CPU 18 determines whether an instruction has been given by the user for ending the performance of the music piece. If such an instruction for ending the performance of the music piece has not been given as determined at step S105, the CPU 18 reverts the processing back to step S102, but, if such an instruction has been given as determined at step S105, the CPU 18 proceeds to step S106 to execute data generation and storage.

At step S106, the CPU 18 generates the temporarily-stored vibration waveform data as music reproducing data, which are a set of vibration waveform data, in the afore-mentioned manner. As another process parallel or concurrent with the above data generation, the CPU 18 generates key drive data and pedal drive data synchronized to the vibration waveform data, on the basis of the detection results of the key sensors 22, pedal sensor 23 and hammer sensors 24. Alternatively, the key drive data may be generated only on the basis of the detection results of the key sensors 22, in which case the detection results of the hammer sensors 24 are not necessary. Further, the CPU 18 stores the generated music reproducing data and the key drive data and pedal drive data in the storage device 12 with the key drive data and pedal drive data associated with the music reproducing data. Then, the instant recording process is brought to an end.

As seen from the foregoing, in the string striking mode, i.e. at the time of recording, the controller 11 functions as a controller that performs control for storing a time series of vibration waveforms, detected by the vibration waveform detector (50) in correspondence with a music piece or phrase performed using the performance operation key (key 2), into a memory (storage device 12). Note that the memory for storing the vibration waveform is not limited to the storage device 12 and may be a removable, portable storage medium or an external storage device connected to the piano 1 via a network,

FIG. 7 is a flow chart of the music piece reproduction processing, which is performed by the CPU 18 of the controller 11. For the music piece reproduction processing of FIG. 7, the CPU 18 makes various settings in accordance with instructions input by the user via the operation panel 13 and the touch panel 60. The various settings may include, among other things: a setting of a volume with which a sound is to be generated by the sound board 7 on the basis of a sound board drive signal (i.e., degree of excitation by the air vibration sensor/actuator unit 50); settings of propriety of driving of the keys 2 and pedal 3 based on the key drive signals and pedal drive signals; a setting of propriety of electronic sound generation based on the key drive signals and pedal drive signals and settings of a sound color and volume.

In FIG. 7, the CPU 18 first makes a determination, at step S201, as to whether the user has given an instruction for starting reproduction of a music piece based on the music piece reproducing data. If such an instruction for starting reproduction of a music piece has been given as determined at step S201, the CPU 18 sets the sound generation mode in the string-striking preventing mode at step S202 and reads out the music piece reproducing data, key drive data and pedal drive data of the entire music piece from the storage device 12 to the RAM 19 at step S203.

The data read out at step S203 above are passed to and processed by another process (not shown) being performed in parallel with the instant music piece reproduction processing. The other process is performed by the CPU 18 at predetermined time intervals.

In the other process, the CPU 18 controls the signal generation section 15 to generate various drive signals. The CPU 18 first controls the signal generation section 15 to generate key drive signals for driving the key drive unit 30 and pedal drive signals for driving the pedal drive unit 31, but also controls the signal generation section 15 to generate a sound board drive signal on the basis of the music piece reproducing data read out to the RAM 19.

Then, the CPU 18 outputs the generated key drive signals and pedal drive signals to the key drive unit 30 and the pedal drive unit 31, respectively, but also outputs the generated sound board drive signal to the drive circuit of the vibration sensor/actuator unit 50. The key drive signals and pedal drive signals represent target trajectories of the keys 2 and pedal 3 corresponding to a temporal progression or passage of time. Thus, in accordance with a progression of the music piece, the keys 2 and the pedal 3 are controlled in respective positions in accordance with the sequentially-generated key drive signals and pedal drive signals, so that the same behavior as in the performance recording processing can be automatically executed.

Once the sound board drive signal is supplied to the vibration sensor/actuator unit 50, vibrations are given to the sound board 7, so that a sound is audibly generated on the basis of a combination of the given vibrations of the sound board 7 and subsequent resonant vibrations of the string 5; namely, first, the sound board 7 vibrates to generate a vibration sound and the strings 5 resonate in response to such vibrations of the sound board 7, so that resonant vibration sounds of the strings 5 are added to the vibration sound of the sound board 7. Such operations are repeated in accordance with the continuous vibration waveform.

Because the keys 2 and the pedals 3 behave in the same way as in the performance recording processing, the dampers 8 too behave in the same way as in the performance recording processing. For example, with the pedal 3 held in the depressed position, rich resonant sounds can be generated by the strings 5. Further, upon release of any one of the keys 2 depressed with the pedal 3 held in the non-depressed position, the corresponding damper 8 silences the corresponding string 5.

With such arrangements, rich audible sounds with resonant sounds, very much similar to those generated when the piano 1 was performed as an acoustic piano, can be generated without actual string striking being performed. Besides, because actual string striking is not performed, it is possible to make desired sound volume adjustment while still maintaining natural sounds, but also it is possible to perform volume-suppressed sound reproduction. Thus, although no actual string striking is performed, it is possible to execute an automatically-damper-controlled, expressive sound board performance because the keys 2 are actually moved. With such actual movements of the keys 2, it is also possible to increase a realistic sensation of an automatic performance.

If a phenomenon like excessive resonance occurs due to the vibrations of the sound board 7 based on the music piece reproducing data, the resonance may be controlled by controlling the driving of the pedal 3 to thereby control the damper position.

As seen from the foregoing, in the string-striking preventing mode, i.e. during the reproduction, the controller 11 functions as a controller that receives a signal indicative of a vibration waveform and supplies the received signal indicative of the vibration waveform to the excitation device (50).

According to the first embodiment, the vibration sensor/actuator unit 50, functioning as both an excitation means or device and a vibration waveform detection means or section, is provided on a portion of the sound board 7 close to the bridge 6, and music piece reproducing data are recorded on the basis of detection results of a vibration waveform of the sound board 7 during a performance of a music piece. Then, in the music piece reproduction processing, a sound board drive signal is generated, on the basis of the music piece reproducing data, to vibrate the sound board 7 by means of the vibration sensor/actuator unit 50 in the string-striking preventing mode. Thus, in the reproduction of the recorded music piece performance data (i.e., music piece reproducing data), the instant embodiment can faithfully reproduce the same acoustic characteristics as an acoustic piano as presented in the performance recording but also permits sound volume adjustment.

Further, because the vibration sensor/actuator unit 50 comprises one and the same hardware functioning both as the excitation device and as the vibration waveform detector, its vibration detecting position and its exciting position can completely coincide with each other. Thus, the instant embodiment can not only even more faithfully reproduce the same acoustic characteristics as presented in the data recording, but also simplify the construction by minimizing increase in the number of necessary component parts.

Further, in the performance recording, the instant embodiment detects operations of the keys 2 and pedal 3 while simultaneously (or concurrently with) detecting a vibration waveform of the sound board 7 and thereby stores in advance key drive data and pedal drive data and music piece reproducing data in association with each other. Then, the instant embodiment actuates the keys 2 and pedal 3 on the basis of the key drive data and pedal drive data while simultaneously reproducing the music piece reproducing data. Thus, damping of the strings 5 is canceled in response to the operations of the keys 2 and pedal 3 automatically driven during reproduction of the music piece, so that resonant sounds can be reproduced even more properly.

Note that, in the reproduction of the music piece reproducing data, sound generation only by the sound board 7 may be performed without the keys 2 and/or the pedal 3 being automatically driven. In such a case, operations of the keys 2 and/or the pedal 3 need not be detected, or the key drive data and/or the pedal drive data need not be read out in the music piece reproduction processing.

### Second Embodiment

A second embodiment of the present invention is generally similar to the above-described first embodiment, except for positions of the vibration senor/actuator units 50. Namely, in the second embodiment, each of the vibration senor/actuator units 50 is connected to the bridge 6 rather than to the sound board 7.

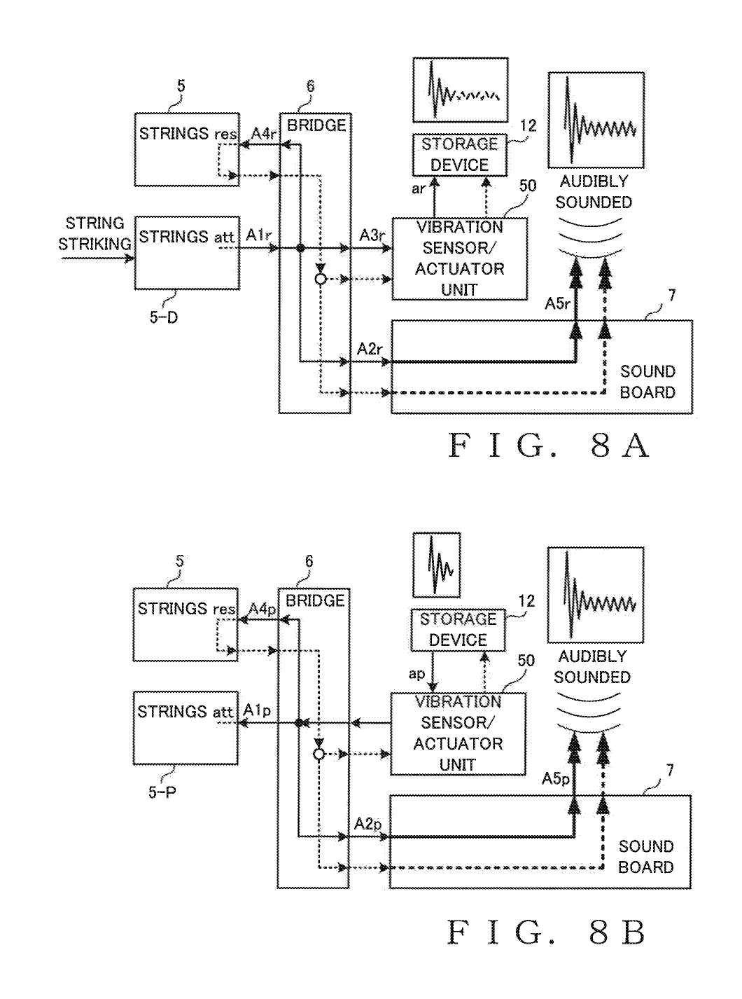

FIG. 8A is a diagram showing propagation paths of vibrations during the recording processing in which music piece reproducing data are recorded in the string striking mode. FIG. 8B is a diagram showing propagation paths of vibrations during the music piece reproduction processing in which sounds are generated via the sound board on the basis of the music piece reproducing data in the string-striking preventing mode.

In response to depression of any one of the keys 2, vibrations of the string 5-D struck by the corresponding hammer transmits from the string 5-D to the bridge 6 (arrow A1r), then from the bridge 6 to the sound board 7 (arrow A2r) and then audibly sounded (arrow A5r), as Shown in FIG. 8A. Meanwhile, the vibrations of the string 5-D transmits via the bridge 6 to the other strings 5 (arrow A4r) but also transmits via the bridge 6 to each of the vibration senor/actuator units 50 (arrow A3r) and recorded into the storage device 12 (arrow ar).

In the music piece reproduction processing, a drive signal similar to the drive signal shown in FIG. 5B is supplied to the vibration senor/actuator unit 50 (arrow ap), as shown in FIG. 8B. Thus, the vibration senor/actuator unit 50 can excite the bridge 6 in accordance with the same vibration waveform as in the recording processing.

As the bridge 6 is excited, vibrations of the bridge 6 transmit to the string 5-P and other strings 5 (arrows A1p and A4p) so that the string 5-P and the other strings 5 resonate. Meanwhile, the vibrations of the bridge 6 transmit to the sound board 7 (arrow A2p) and then audibly sounded (arrow A5p). Also, because of resonance of the other strings 5, the vibrations transmit to the bridge 6, then to the sound board 7 and audibly sounded. Meanwhile, the vibrations of the other strings 5 transmit via the bridge 6 to the vibration senor/actuator unit 50.

With such arrangements, the second embodiment can achieve the same advantageous benefits as the first embodiment; namely, in reproduction of the recorded music piece performance data, the second embodiment can faithfully replicate or reproduce the acoustic characteristics as an acoustic piano as presented in the performance recording and permits sound volume adjustment.

Whereas the vibration senor/actuator unit 50 provided in the first and second embodiments of the invention has been described as a single hardware component functioning as both the excitation device and the vibration waveform detector, the excitation device and the vibration waveform detector may be provided separately from each other as noted above. In such a case, the excitation device and the vibration waveform detector may be disposed on the bridge 6 or on a portion of the sound board 7 close to the bridge 6. Because, if the excitation device and the vibration waveform detector are within such a region, no significant differences would arise irrespective whether the excitation device and the vibration waveform detector are on the bridge 6 or on the sound board 7. Anyway, in order to achieve faithful reproduction of sounds, it is desirable that the excitation device and the vibration waveform detector be located as close to each other as possible.

Further, the music piece reproducing data and the drive data may be temporarily recorded in a portable medium or the like and read out and used as necessary without being limited to being recorded in the storage device 12 provided in the grand piano 1. Whereas it is most desirable that the piano that performs the data recording processing and the piano that performs the music piece reproduction processing by use of the recorded data be one and the same piano, the present invention is not so limited, and the data recording and the data reproduction may be performed by physically separate pianos of a same model; namely, the data recording may be performed by a first piano of model A and the data reproduction may be performed by a second piano of model A.

It should be appreciated that the piano to which the basic principles of the present invention are applied may be of the upright type rather than the grand type as along as it has a sound board capable of being compulsorily vibrated. Further, the basic principles of the present invention may be applied to any other musical instruments than pianos; note that the “musical instruments” to which the basic principles of the present invention are not necessary limited to real musical instruments and may be musical-instrument-type toys, equipment having similar functions to musical instruments, and the like. Furthermore, apparatus constructed to have only the reproduction function without having the recording function are also included in the scope of the present invention. Namely, the present invention may be constructed as a sound reproduction apparatus comprising: a sound board; an excitation device physically excitable in accordance with an input waveform signal and disposed in such a manner that physical vibrations generated by the excitation device are transmitted at least to the sound board; and a controller configured to receive a signal indicative of a vibration waveform of the sound board and input the received signal indicative of the vibration waveform to the excitation device, so that physical vibrations according to the input signal indicative of the vibration waveform are generated by the excitation device and a sound is generated by at least the sound board physically vibrating in response to the physical vibrations generated by the excitation device.

This application is based on, and claims priority to, JP PA 2012-264190 filed on 3 Dec. 2012. The disclosure of the priority application, in its entirety, including the drawings, claims, and the specification thereof, are incorporated herein by reference.

What is claimed is:

1. A musical instrument comprising;
at least one performance operation key;
at least one sounding member each provided in association with one of said at least one performance operation key;
a sound board;
at least one striking member each configured to physically vibrate one of said at least one sounding member in response to an operation of said at least one performance operation key;
a transmission joint disposed in such a manner as to physically transmit vibrations of said at least one sounding member to said sound board;
a vibration waveform detector configured to detect a vibration waveform corresponding to vibrations of at least one of said sound board and said transmission joint; and
a controller configured to perform control for storing, into a memory, a time series of the vibration waveforms detected by said vibration waveform detector in correspondence with a music piece or phrase performed using said at least one performance operation key.

2. The musical instrument as claimed in claim 1, which further comprises an operation detector configured to detect an operation of said at least one performance operation key, and
wherein said controller stores information identifying the at least one performance operation key whose operation has been detected by said operation detector and the vibration waveform into the memory in time-serial association with each other.

3. The musical instrument as claimed in claim 1, which further comprises:
a damper device operable to damp vibrations of said at least one sounding member; and
a damper behavior detector configured to detect behavior of said damper device, and
wherein said controller stores information indicative of the behavior of said damper device detected by said damper behavior detector and the vibration waveform into the memory in time-serial association with each other.

4. The musical instrument as claimed in claim 1, wherein said sounding member is a string, said striking member is a hammer, and said transmission joint is a bridge provided on said sounding member for supporting the string in a stretched-taut state.

5. The musical instrument as claimed in claim 1, which further comprises an excitation device physically excitable in accordance with an input waveform signal and disposed in such a manner that physical vibrations generated by said excitation device are transmitted at least to said sound board,
wherein said controller is configured to further receive a waveform signal based on the time series of the vibration waveforms stored in said memory and input the received waveform signal to said excitation device, so that physical vibrations according to the input waveform signal are generated by said excitation device and sounds of the music piece or phrase are generated by at least said sound board physically vibrating in response to the physical vibrations generated by said excitation device.

6. The musical instrument as claimed in claim 5, wherein said excitation device is a device that comprises same hardware as said vibration waveform detector.

7. A sound reproduction apparatus comprising:
a sound board;
an excitation device physically excitable in accordance with an input waveform signal and disposed in such a manner that physical vibrations generated by said excitation device are transmitted at least to said sound board; and
a controller configured to receive a signal indicative of a vibration waveform of said sound board and input the received signal indicative of the vibration waveform to said excitation device, so that physical vibrations according to the input signal indicative of the vibration waveform are generated by said excitation device and a sound is generated by at least said sound board physically vibrating in response to the physical vibrations generated by said excitation device.

8. The sound reproduction apparatus as claimed in claim 7, wherein said signal indicative of the vibration waveform received by the controller comprises a time series of vibration waveforms corresponding to a music piece or phrase so that sounds of the music piece or phrase are generated by the physical vibrations of the sound board.

9. The sound reproduction apparatus as claimed in claim 7, wherein the vibration waveform is stored in a memory, and said controller receives the vibration waveform read out from the memory.

10. The sound reproduction apparatus as claimed in claim 7, wherein the vibration waveform is a vibration waveform detected by a vibration waveform detector of a musical instrument, and said musical instrument comprises:
at least one performance operation key;
at least one sounding member configured to physically vibrate in response to an operation of said at least one performance operation key;
a sound board;
a transmission joint disposed in such a manner as to physically transmit vibrations of said at least one sounding member to said sound board; and
said vibration waveform detector configured to detect a vibration waveform corresponding to vibrations of at least one of said sound board and said transmission joint.

11. The sound reproduction apparatus as claimed in claim 10, which is mounted on said musical instrument, and wherein said excitation device is a device comprising same hardware as said vibration waveform detector.

12. The sound reproduction apparatus as claimed in claim 10, which further comprises a drive unit configured to automatically drive said at least one performance operation key, and
wherein said controller receives, in association with the received signal indicative of the vibration waveform, information identifying said at least one performance operation key and automatically drives said at least one performance operation key via said drive unit on a basis of the received information identifying said at least one performance operation key.

13. The sound reproduction apparatus as claimed in claim 12, which further comprises a prevention device configured to prevent said at least one sounding member from physically vibrating in response to an operation of said at least one performance operation key; and
wherein, when said controller automatically drives said at least one performance operation key via said drive unit on the basis of the received information identifying said at least one performance operation key, said controller actuates said prevention device to prevent said at least one sounding member from physically vibrating.

14. The sound reproduction apparatus as claimed in claim 10, which further comprises a damper device operable to damp vibrations of said at least one sounding member; and
a damper drive unit configured to automatically drive said damper device, and
wherein said controller receives, in association with the received signal indicative of the vibration waveform, information indicative of behavior of said damper device and automatically drives said damper device via said damper drive unit on a basis of the information indicative of the behavior of said damper device.

15. A computer-implemented method for storing performance information of a musical instrument, the musical instrument comprising: at least one performance operation key; at least one sounding member each provided in association with one of the at least one performance operation key; a sound board; at least one striking member each configured to physically vibrate one of the at least one sounding member in response to an operation of the at least one performance operation key; and a transmission joint disposed in such a manner as to physically transmit vibrations of the at least one sounding member to the sound board, said method comprising:
a detection step of detecting a vibration waveform corresponding to vibrations of at least one of the sound board and the transmission joint; and
a step of storing, into a memory, a time series of the vibration waveforms detected by said detection step in correspondence with a music piece or phrase performed using said at least one performance operation key.

16. A computer-implemented method for reproducing a sound in a sound reproduction apparatus, the sound reproduction apparatus comprising: a sound board; and an excitation device physically excitable in accordance with an input waveform signal and disposed in such a manner that physical vibrations generated by the excitation device are transmitted at least to the sound board, said method comprising
a step of receiving a signal indicative of a vibration waveform of the sound board and inputting the received signal indicative of the vibration waveform to the excitation device,
wherein physical vibrations according to the input waveform signal are generated by the excitation device and a sound is generated by at least the sound board physically vibrating in response to the physical vibrations generated by the excitation device.

17. A non-transitory computer-readable storage medium storing a program executable by a processor to perform a method for storing performance information of a musical instrument, the musical instrument comprising: at least one performance operation key; at least one sounding member each provided in association with one of the at least one performance operation key; a sound board; at least one striking member each configured to physically vibrate one of the at least one sounding member in response to an operation of the at least one performance operation key; and a transmission joint disposed in such a manner as to physically transmit vibrations of the at least one sounding member to the sound board, said method comprising:
a detection step of detecting a vibration waveform corresponding to vibrations of at least one of the sound board and the transmission joint; and
a step of storing, into a memory, a time series of the vibration waveforms detected by said detection step in correspondence with a music piece or phrase performed using said at least one performance operation key.

18. A non-transitory computer-readable storage medium storing a program executable by a processor to perform a method for reproducing a sound in a sound reproduction apparatus, the sound reproduction apparatus comprising: a sound board; and an excitation device physically excitable in accordance with an input waveform signal and disposed in such a manner that physical vibrations generated by the excitation device are transmitted at least to the sound board, said method comprising
a step of receiving a signal indicative of a vibration waveform of the sound board and inputting the received signal indicative of the vibration waveform to the excitation device,
wherein physical vibrations according to the input waveform signal are generated by the excitation device and a sound is generated by at least the sound board physically vibrating in response to the physical vibrations generated by the excitation device.
